(19) United States
(12) Patent Application Publication
(10) Pub. No.: US 2006/0161295 A1
(43) Pub. Date: Jul. 20, 2006

(54) Telemedic monitoring system

(76) Inventor: Paul M. Yun, Bristow, VA (US)

Correspondence Address: Carole A. Mulchinski;The Aerospace Corporation, M1/040, 2350 East El Segundo Boulevard, El Segundo, CA, 90245, US

(21) Appl. No.: 11/000,466

(22) Filed: Nov. 30, 2004

(51) Int. Cl. G06F 17/00

(52) U.S. Cl. 700/236

(57) ABSTRACT

A telemedic monitoring system dispenses medication on a prescribed schedule and monitors the dispensing device to determine when a patient, such as an elderly patient, has actually taken the medication from the dispensing device, and reports the same to a central system that can relay messages to relatives of the patient so that drug dispensing can be remotely monitored, and when the system detects an anomaly, an alert will be issued to the patient's relatives to resolve complications of elder care services.

### BACKGROUND OF THE INVENTION

Mature adults often experience difficulties when receiving elder care, typically due to various physical and mental illnesses. Today more than forty-seven million Americans are sixty years old or older. As the baby-boomers reach their retirement ages, it is expected that the population of those over sixty years old Americans will be doubled that of today. Unfortunately, a majority of them will require some form of elder care service either at homes or elder care centers. For those who have their parents in elder care centers, it is desirable that the parents are taking the daily dosage of prescription drugs. Often, those concerned have to make recurring phone calls to check up upon their parents or ill family members, often, when it is not convenient to do so. These and other disadvantages are solved or reduced using the invention.

### SUMMARY OF THE INVENTION

An object of the invention is to provide a system for monitoring dispensed medication.

Another object of the invention is to provide a system for dispensing medication and monitoring dispensed medication consumption.

Yet another object of the invention is to provide a system for dispensing medication on a predetermined schedule and monitoring dispensed medication consumption.

Still another object of the invention is to provide a system for dispensing medication on a predetermined schedule and monitoring dispensed medication consumption for reporting to predetermined recipients.

A further object of the invention is to provide a system for dispensing medication on a predetermined schedule and monitoring dispensed medication consumption for reporting to predetermined recipients to alert the recipients when drugs have or have not been properly consumed.

The present invention is directed to a drug dispensing and monitoring system for monitoring the care of patients. In addition, the system can alert the relatives of patients if the pills were not taken and/or some irregular activities were detected. The system includes an elder care unit that dispenses by predetermined drug dispensing schedule and monitors the drug dispensing means for determining when the patient actually removes the drug from the dispenser for indicating that the prescribed drugs have been properly dispensed and consumed by the patient. The monitoring system can report to relatives of the patient for remote reporting of drug dispensing and consumption. The system may relieve worries of the family members who have parents in elderly care centers, that is, whether or not their elderly parents are taking the required dosage of prescription drugs on a daily scheduled basis. The system can be applied to a wide range of drug dispensing and monitoring applications in elder care. The system provides elder care monitoring systems that can span various drug regimes, including pills, drinks, and injections without intruding upon the privacy of elder patients. These and other advantages will become more apparent from the following detailed description of the preferred embodiment.

### BRIEF DESCRIPTION OF THE DRAWINGS

FIG. 1 is block diagram of a health care monitoring network.

FIG. 2 is block diagram of an automatic drug dispensing and monitoring system.

### DETAILED DESCRIPTION OF THE PREFERRED EMBODIMENT

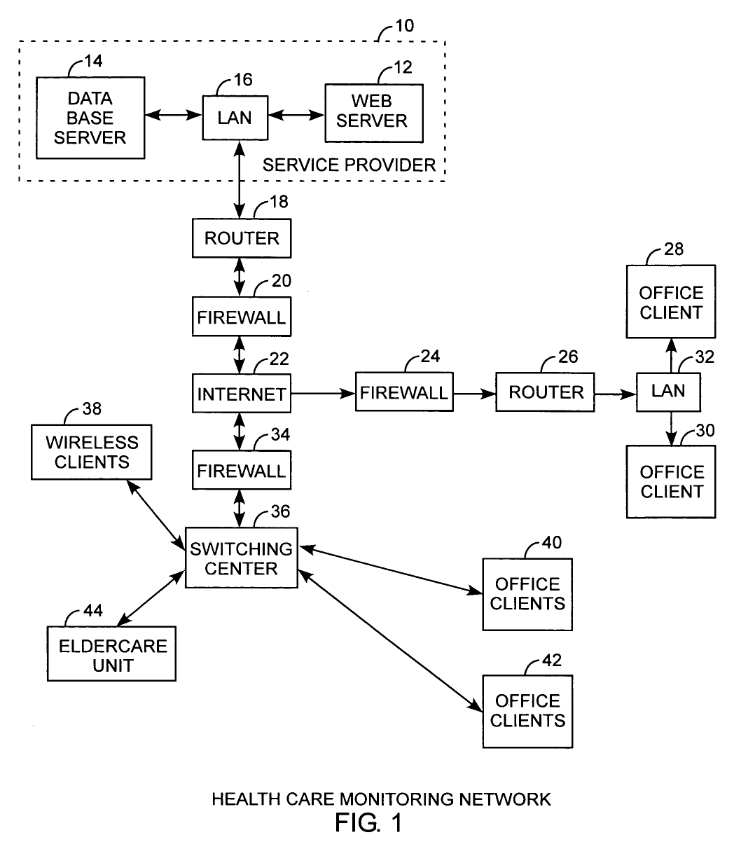

An embodiment of the invention is described with reference to the figures using reference designations as shown in the figures. Referring to FIG. 1, a service provider 10 may include a web server and a database server 14 interconnected by a local area network 16 for communications typically through a router 18 and a firewall 20 to the internet 22. The communications can be routed through another firewall 24 and router 26 to a first office client and a second office client 30 also interconnected by a local area network. The office clients 28 and 30 can be various user browsers for logging into the service provider for accessing information on the state of drug dispensing and usage. The internet 22 may also be connected through a third firewall 34 to a switching center 36, such as a phone-switching center. The switching center 35 provides cellular and land line phone communications to other office clients, such as wireless clients 38 and office clients 40 and 42, such as for phone communications to a users browser. The switching center 36 can also receive calls from an elder care center 44 for receiving messages and communicating dispensing schedules.

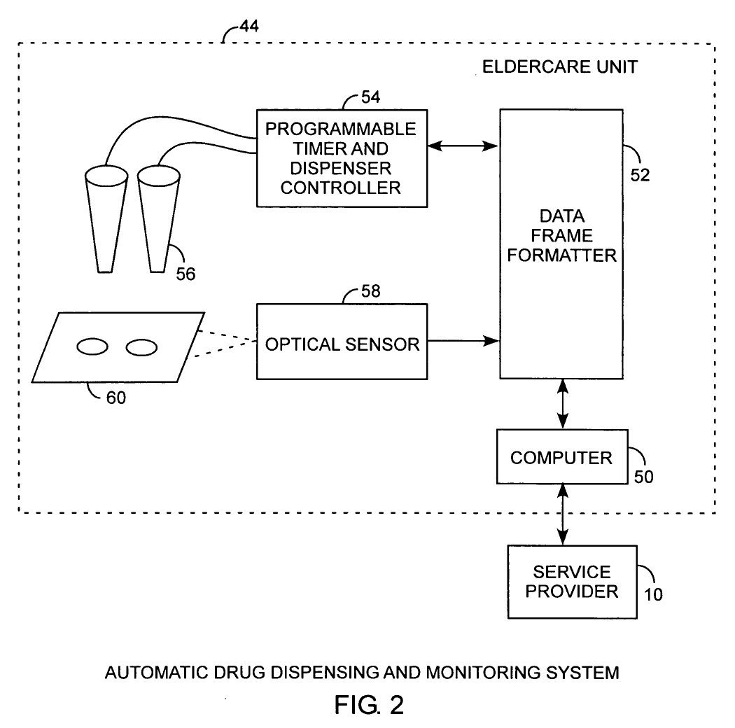

Referring to FIGS. 1 and 2, and more particularly to FIG. 2, the elder care unit 44 may be a residence or eldercare site wherein is house a patient. The service provider 10 sends a predetermined drug-dispensing schedule to a personal computer 50 located in the elder care center through online internet connections. The computer 50 would preferably operate with a data frame formatter 52 communicating dispensing instructions to and driving a programmable timer and dispenser controller 54 for dispensing drugs through a dispenser 56. An optical sensor 58 would monitor a drug receptacle for determining that the drugs were dispensed when driven and that drugs were subsequently removed, usually by patient's conduct. In the event that the drugs were not properly dispensed, such as when running out of supply, or in the event that the dispense drugs were not removed from the receptacle, the computer 50 can track the dispensing operation. The computer 50 can log dispensing and consuming actions as well as send reports to the service provider 10 or emergency reports to alert the patient's relatives at the clients 28, 30, 38, 40, and 42. In this manner, drug dispensing schedules and patient consumption can be remotely monitored to ensure timely consumption of drugs by elder care patients, with rapid reporting of the status of the drug consumption.

As such, the telemedic systems monitors, logs, and services the interactive actions of prescription drug dispensers that are being accessed by a patient who has to take prescription drugs on a daily basis or predetermined schedule. The system is an automatic drug dispenser and monitoring systems in telemedic applications for improved care of elder care patients. The exemplar network architecture can support commercial deployments of several telemedic applications, of various type of drugs and methods of consumption. For example, the dispenser 56 can be hypodermic needles through which drugs are dispensed while a patients arm rests on the receptacle 60. For another example, the dispenser can be a medical assay that pricks a limb resting on the receptacle 60 when the limb is in view and placed on the receptacle 60, such that, the system dispenses drugs and assays. When assays are performed, the patient may rest a limb on the receptacle. The optical sensor 58 can be replaced with a pressure sensor to indicate that weight has been placed upon the receptacle indicating that the patient placed a limb at the correct time. Further still, the dispenser 56 could include medical sensors for obtaining assay information that is fed back to the computer through the controller in 54. In this manner, a medical event is controlled and patient interaction is detected. In the general form of the invention, the eldercare unit 44 provides medical dispensing and patient sensing that can be directed to a wide variety of medical schedules events, such as, pills, solids, liquids, gases, and assays, for dispensing on a regular predetermined schedule.

Typically, the system in the elder care unit 44 will automatically dispense a daily dosage of required prescription drugs at the preprogrammed time of day, and monitor the patient interactions with the dispensed drugs when the drugs are supposed to be taken. The monitored and sensed signals are converted in a digital frame format, and will be sent to the service provider 10 through the internet, where the data can are archived and relayed as desired. The archived data in the database 14 will be available to the clients with adequate security to protect the privacy of elder patients. The clients can access the database from their office, home, or mobile phones at anytime and anywhere. The service provider 10 can alert clients when there are no interactions in the systems that may indicate the drugs have not been taken. The clients, who received the alert, can then take an appropriate corrective action.

The eldercare unit has the programmable timer and dispenser controller 54, optical sensor 58, frame formatter 52, and computer 50 that all can be integrated as a stand alone unit, with the dispenser 56 and receptacle 60 being tailored to the type of medical event being monitored. The programmable timer and dispenser will control the release of drugs on a daily basis. For example, the amount of drugs to be discharged and time to release are programmed by the administrator who provides the elderly care services. The optical sensor monitors the drugs being removed by the elderly and sends status to the frame formatter. The frame formatter assembles data for driving the controller 54 and assembles data from the optical sensor 58, for indicating whether the elderly patient took the drugs. Additional data, such as, the time of day, is used to indicate when the drugs were released and when the drugs are consumed. The frame formatter can then append information for communication to the service provider 10.

A link layer for the systems is used to complete a protocol stack for internet communications. The communicated data can be fashioned for various needs. For example, the data can include type of dispensing, such as, pills, liquid, solid, gas, assays, the type of consumption, such as oral consumption or skin puncturing. The data would also include the time of dispensing and the time of consumption. The computer can read the frame formatter 52 to obtain the data and then sends the data to the service provider 10. The service provider 10 archives and makes the data available so that the clients with correct authentication and accounts can access the data anytime and anywhere.

The present invention is directed to an elder care center telemedic dispensing and monitoring system for dispensing medication and sensing consumption. Various types of medication can be used, such as pills, solids, liquids, gases, injections, and assays. Various types of sensors can be used, such as medication removal, limb pressure sensing, among others. Those skilled in the art can make enhancements, improvements, and modifications to the invention, and these enhancements, improvements, and modifications may nonetheless fall within the spirit and scope of the following claims.

What is claimed is:

1. A system for monitoring the dispensing of medication, the system comprising,
a service provider,
an elder care unit, the elder care comprising a communications means and a sensor means and a receptacle and a controller and a dispenser, the eldercare system for controlling the dispensing of medication and sensing the consumption of the medication, the elder care unit for receiving a medication schedule from the service provider and for dispensing the medication on the medication schedules and for reporting to the service provider and alerting to the patient's relatives, and
a client connected to the service provider by communications for receiving reports from the service provider for indicating that the medication was consumed on the medication schedule.

2. The system of claim 1 wherein,
the medication is selected from the group consisting of pills, solids, liquids, and gasses.

3. The system of claim 1 wherein,
the sensor is an optical sensor,

4. The system of claim 1 wherein,
the medication is an injection, and
the sensor is a weight sensor for indicating weight upon the receptacle indicating the consumption of the injection.

5. The system of claim 1 wherein,
the medication is an assay,
the sensor is a weight sensor for indicating weight upon the receptacle indicating exposure to the assay,
the controller provides assay data for communication to the service provider.
